(19) United States
(12) Patent Application Publication
(10) Pub. No.: US 2013/0196196 A1
(43) Pub. Date: Aug. 1, 2013

(54) BATTERY WITH TEMPERATURE DETECTION, AND USE OF A BATTERY SUCH AS THIS

(71) Applicants: Ossama Obeidi, Berlin (DE); Michael Schiermann, Berlin (DE); Peter Birke, Glienicke/Nordbahn (DE); Hans-Georg Schweiger, Ingolstadt (DE); Nevzat Guener, Berlin (DE)

(72) Inventors: Ossama Obeidi, Berlin (DE); Michael Schiermann, Berlin (DE); Peter Birke, Glienicke/Nordbahn (DE); Hans-Georg Schweiger, Ingolstadt (DE); Nevzat Guener, Berlin (DE)

(73) Assignee: CONTINENTAL AUTOMOTIVE GMBH, HANNOVER (DE)

(21) Appl. No.: 13/702,661

(22) PCT Filed: Apr. 28, 2011
(86) PCT No.: PCT/EP11/56706

§ 371 Date: Jan. 9, 2013

(30) Foreign Application Priority Data
Jun. 7, 2010 (DE) 102010022908.3

(51) Int. Cl. H01M 2/12

(52) U.S. Cl. CPC H01M 2/12
USPC 429/82; 429/72

(57) ABSTRACT

A battery includes a plurality of flat cells which are electrically connected in parallel and/or in series with one another and which, when disposed next to one another in rows perpendicular to their flat sides, form a substantially prismatic configuration. In order to obtain more accurate information about the state of the individual flat cells during operation of the battery and, for example, to allow such information to be used for matched temperature management, a heat dissipation plate, which is thermally linked to at least one flat side of a plurality of the flat cells and in each of which at least one temperature sensor is integrated, is provided in each case in the configuration. The battery may be used for spatially resolved battery temperature measurement.

The present invention relates to a battery as claimed in the precharacterizing clause of claim 1, in particular for use in a vehicle, for example as a traction battery in an electric or hybrid vehicle.

A battery of this kind is disclosed, for example, in DE 10 2008 010 825 A1. By way of example, the disclosed battery contains approximately 30 rectangular flat cells which are electrically connected to one another and which, when arranged next to one another in a row orthogonally with respect to their flat sides, form a cuboid-shaped flat cell stack. The individual flat cells rest immediately against one another in this stack and are thermally connected on one of their narrow sides in each case to a common heat conducting plate. The heat conducting plate can be connected to an air conditioning circuit of a vehicle, for example, in order to be able to control the temperature of (in particular cool) the battery thereby.

Although the disclosed battery has a compact design with more or less good heat dissipating capability (via the heat conducting plate), the problem exists that the performance capability of the battery deteriorates in the course of time due to degradation (aging) or failure of individual flat cells.

It is an object of the present invention to improve a battery of the kind mentioned in the introduction in such a way that more accurate information relating to the state of the individual flat cells can be obtained while the battery is in operation. With a battery according to the invention, this object is achieved in that, in the arrangement, a heat dissipating plate, in which, in each case, at least one temperature sensor is integrated, is in each case provided on at least one flat side of a plurality of the flat cells and is thermally connected thereto.

In an improvement, such heat dissipating plates are even provided for most, in particular for all, of the flat cells in the arrangement. This, again, on at least one flat side in each case, and if necessary therefore also on both flat sides of the flat cells concerned.

The thermal connection of the heat dissipating plate to the flat side of a flat cell can be realized, for example, in a simple manner by placing the heat dissipating plate flat on this flat side (with or without an intermediate film, such as for example heat conducting adhesive or similar).

With the invention, in each case at least one temperature sensor, which is integrated in a heat dissipating plate which is thermally connected to the flat cell concerned, is associated with a plurality (in particular at least 25%, at least 50%, or even all) of the flat cells.

In the case of an abnormal temperature of the flat cell, this sensor thus provides a sensor signal, based on which this abnormality (e.g. increased temperature) can be detected. Advantageously, such an abnormality can additionally be spatially localized more or less accurately within the battery or flat cell arrangement. In this regard, it is preferred when the temperature sensors and/or the heat dissipating plates are arranged distributed substantially uniformly over the volume of the arrangement.

Preferably, the substantially prismatic battery cell arrangement comprises at least 10, further preferably at least 20 temperature sensors which are integrated in the manner according to the invention. With a given number of flat cells in the arrangement (e.g. at least 20, preferably at least 40), at least one temperature sensor is preferably provided per flat cell. As an example, the ratio of the number of temperature sensors to the number of flat cells can lie in the range from 1 to 4.

Apart from its energy storage functionality, the battery according to the invention can advantageously be used for a spatially resolved battery temperature measurement. In particular, the present invention therefore further relates to an operating method for a battery of the kind according to the invention, in which (as well as charging and discharging of the battery as required) a spatially resolved battery temperature measurement is carried out by evaluating the temperature sensor signals.

The sensor signals of the individual temperature sensors or a result of the evaluation of all temperature sensor signals, which is carried out, for example, with the aid of software in an electronic evaluation device, can be used in various ways.

For example, with appropriate design of a battery cooling system, a specific cooling of that/those flat cell(s), for which an increased cooling requirement has been established or defined based on the evaluation while the battery is in operation, can be carried out. Independently of such a matched temperature management, information which is useful or necessary for a later specific replacement of one or more flat cells can also be obtained and stored based on the evaluation while the battery is in operation. For example, in the case of a battery used in an electric or hybrid vehicle, such information can be stored in a so-called diagnostics memory in order that a specific replacement of one or more flat cells of the battery can be carried out during a service (e.g. inspection) of the vehicle.

In an embodiment, it is provided that, in each case, the heat dissipating plate is fitted to only one of the two flat sides of the flat cells concerned and is thermally connected thereto. This is of particular advantage with regard to a compact design of the battery. However, notwithstanding this, in particular to increase the measuring accuracy, it is also possible to provide a heat dissipating plate (with at least one temperature sensor integrated therein in each case) on both sides of each of the flat cells concerned.

In an embodiment, it is provided that at least some of the heat dissipating plates, in particular all heat dissipating plates, are thermally connected to flat cells adjacent on both sides.

In an improvement of this embodiment, it is provided that the flat cells form the arrangement alternately stacked with heat dissipating plates, wherein this stack is “densely packed” in order to achieve a particularly compact structure. However, in another, preferred improvement, it is provided that the flat sides of the two flat cells concerned, which in each case face away from the heat dissipating plate, in each case border an air gap or a coolant passage. Apart from the fact that an efficient temperature control (e.g. cooling) can advantageously be carried out with such air gaps or coolant passages, this also advantageously enables a specific temperature control, in particular cooling, to be realized. With such a specific cooling capability, the air gaps or coolant passages can be connected to an air or coolant flow (e.g. “air conditioning circuit”) so that gaps can be supplied with cooling air or coolant (e.g. water or some other liquid) independently of one another. The independent supply can then be carried out (initiated) on the basis of the mentioned evaluation of the temperature sensor signals, for example, in order, for example, to provide greater cooling specifically for that/those flat cell(s) for which an increased cooling requirement has been established.

Regardless of whether such cooling by means of air gaps or coolant passages within the arrangement is provided at all, and regardless of whether or not such cooling enables “spatially resolved” cooling, other heat dissipating measures can also be used alternatively or additionally with the battery according to the invention.

For example, in an embodiment, it is provided that, in each case, the heat dissipating plates are thermally connected to a common heat sink on one of their narrow sides.

In the simplest case, the heat sink can be in the form of a heat conducting plate (with or without “cooling fins”) for example, wherein the narrow sides of the individual heat dissipating plates rest directly on a flat side of this heat conducting plate.

With a heat sink of this kind or a heat conducting plate of this kind, the heat initially transmitted from the individual flat cells to the heat dissipating plates thermally connected thereto can be transmitted further to the heat sink.

When the heat sink is connected to an air conditioning circuit (e.g. to the air conditioning circuit which is in any case provided in a vehicle for air-conditioning an interior), then the heat accumulating at the heat sink can advantageously be further dissipated.

In principle however, it is also conceivable that, depending on the operating situation (requirement-based), the heat sink and therefore the battery can also be heated by means of the air conditioning circuit.

In an embodiment variant, it is provided that in each case the flat cells are also thermally connected to the common heat sink by means of their narrow sides concerned. However, as this is accompanied by thermal paths which run directly (not via the heat dissipating plates) from the flat cells to the heat sink, according to a preferred embodiment variant, it is provided that the narrow sides of the flat cells are not in direct contact with the heat sink. This advantageously increases the validity of the temperature measurement in the heat dissipating plate which is thermally connected to the flat cell.

In an advantageous improvement, the heat dissipating plates are in each case fixed to the heat sink so that, as well as a temperature controlling function, the heat sink also fulfills a mechanical function, namely for retaining the heat dissipating plates in their desired position. Alternatively or in addition, the heat dissipating plates can also be mechanically fixed at some other point in order to retain these in a specified position relative to one another.

The mechanical fixing of the flat cells in their position can advantageously be realized using the heat dissipating plates, for instance when, for example, each flat cell already has at least one heat dissipating plate which is thermally connected thereto associated with it. When the flat cell is fixed to this heat dissipating plate, for example by a screw and/or heat conducting adhesive, then a fixing of the flat cells can be realized “automatically” with a fixing of the heat dissipating plates (to the heat sink).

There are many options for the design of the heat dissipating plates.

In an embodiment, it is provided that the heat dissipating plates are in each case made up of two individual plates, between which the temperature sensor or sensors concerned are inserted. In an intermediate space between the two individual plates, signal wires connected to the temperature sensor or sensors can advantageously be fed to a lateral edge of the heat dissipating plate (and from there further).

In an embodiment, it is provided that the at least one temperature sensor is arranged in a recess of the heat dissipating plate. This recess can be located in a heat dissipating plate which is formed in one piece for example.

Notwithstanding this, with this embodiment, consideration can also be given to forming the heat dissipating plate in two pieces (from two individual plates), wherein, in this case, the recess is preferably provided on the inside of one or both individual plates so that the temperature sensor, which is arranged in the recess, is located inside the heat dissipating plate. The recess can extend in the form of a (preferably narrow) channel to an edge of the heat dissipating plate in order to feed a signal wire of the temperature sensor to this edge (and from there further). Also with this embodiment, a plurality of temperature sensors which are accommodated in a respective (dedicated) recess can be provided for each heat dissipating plate.

When more than one temperature sensor is integrated in a heat dissipating plate, a redundant temperature measurement, for example, can be carried out in the region of this heat dissipating plate, which in turn minimizes a risk of failure, for example, and/or increases the accuracy of the measurement.

However, within the framework of the invention, a plurality of temperature sensors per heat dissipating plate has the additional serious advantage that this enables the spatial resolution of the cell temperature measurement to be further improved. In a preferred embodiment, it is therefore provided that, viewed in at least one lateral direction of the heat dissipating plate, at least two temperature sensors which are spaced apart from one another are integrated in this heat dissipating plate. The evaluation of the sensor signals of these at least two temperature sensors advantageously enables information to be obtained relating to the existing temperature distribution viewed in the lateral direction concerned.

In a preferred improvement, viewed in at least two lateral directions (in particular, directions which are orthogonal to

one another), the plurality of temperature sensors of a heat dissipating plate is integrated in this heat dissipating plate with mutual spacings from one another. At least three temperature sensors integrated in the heat dissipating plate are necessary for this. Advantageously, this enables a temperature measurement resolved over the surface of the heat dissipating plate (or of the flat cell connected thereto) to be realized.

A plurality of temperature sensors of a heat dissipating plate can be arranged “in the form of a grid” in or on this heat dissipating plate. In a preferred embodiment particularly for rectangular flat cells and rectangular heat dissipating plates which are thermally connected thereto, it is provided that the plurality of temperature sensors of each heat dissipating plate is arranged on a rectangular grid, in which (imaginary) connecting lines between the temperature sensors running parallel to the edges of the heat dissipating plate are provided.

With an approximately square heat dissipating plate, for example, four temperature sensors, for example, can be arranged at the corners of an (imaginary) square inscribed on the square contour of the heat dissipating plate.

If a plurality of temperature sensors is integrated in a heat dissipating plate, then a(n) (electronic) multiplexer for operating the at least two temperature sensors can also be integrated in the heat dissipating plate. In particular, the multiplexer can be provided as a component in a data bus system (e.g. “CAN”—Bus).

The invention is described in more detail below based on exemplary embodiments with reference to the attached drawings. In the drawings:

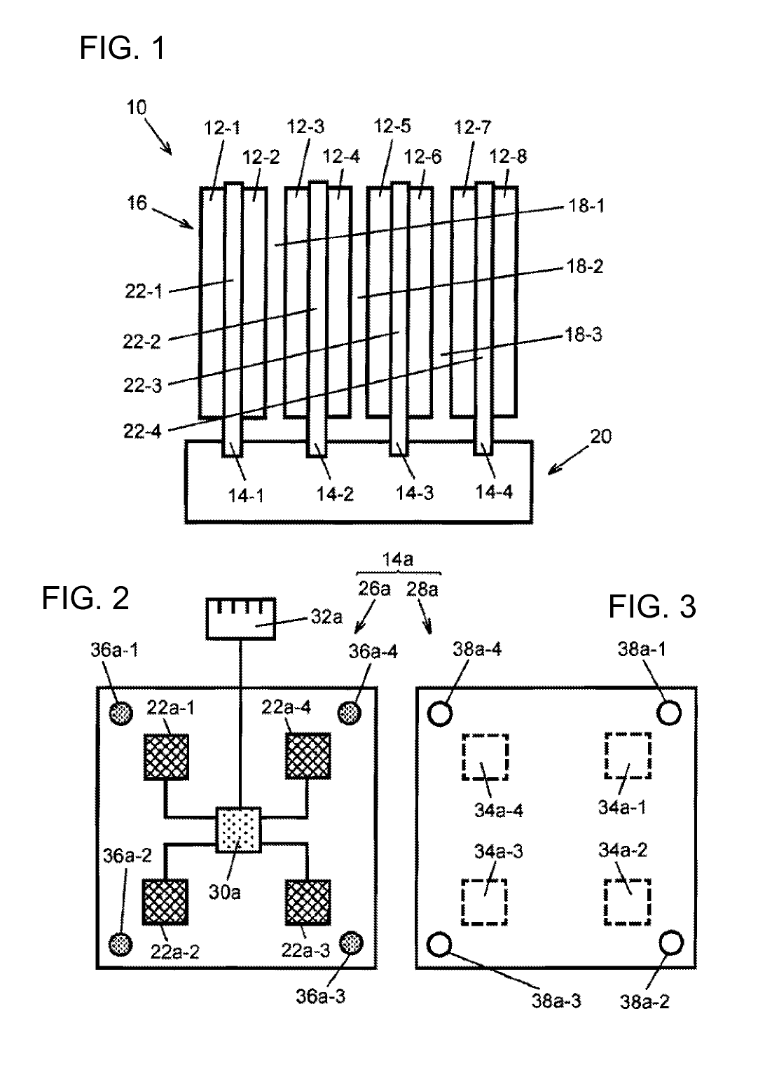

FIG. 1 shows a schematic side view of essential components of a battery according to an exemplary embodiment,

FIGS. 2 and 3 in each case show plan views of two individual plates which can be assembled to form a heat dissipating plate,

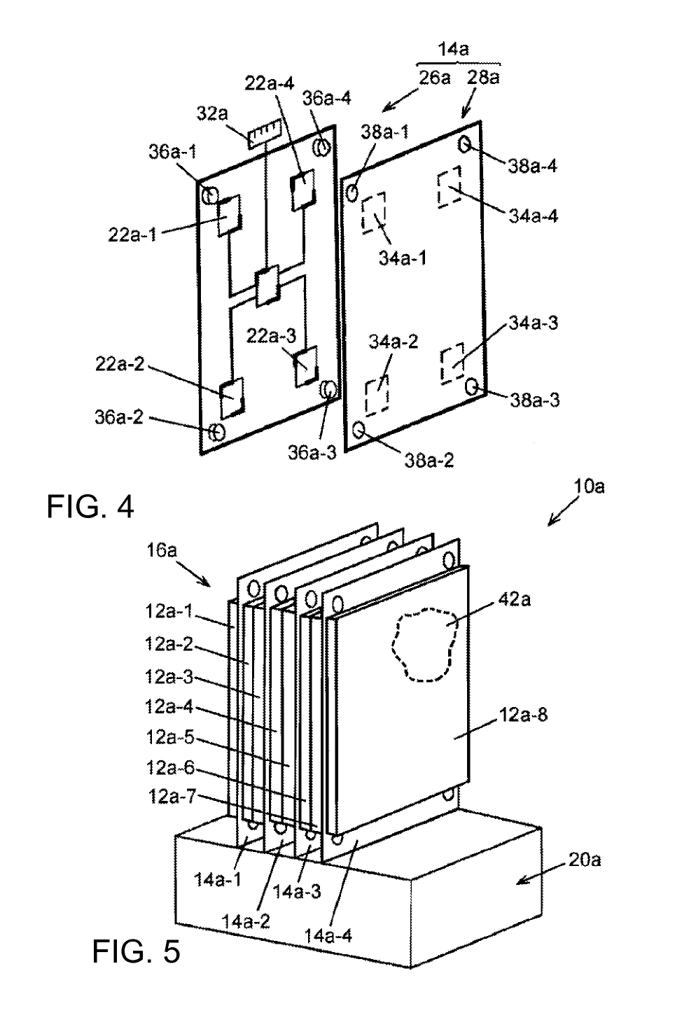

FIG. 4 shows a perspective view of the individual plates of FIGS. 2 and 3,

FIG. 5 shows a perspective view of essential components of a battery according to a further exemplary embodiment, assembled using heat dissipating plates as shown in FIGS. 2 to 4, and

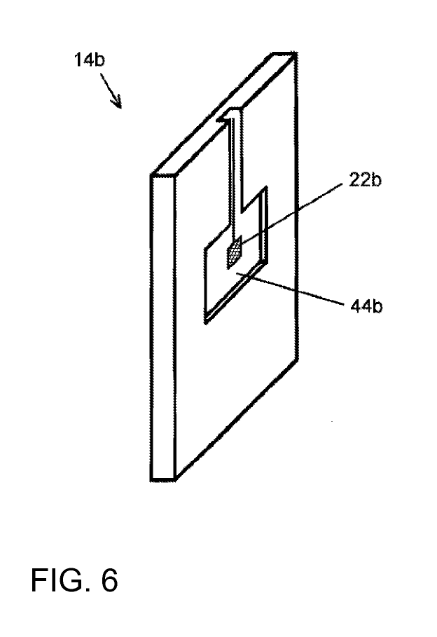

FIG. 6 shows a perspective view of a heat dissipating plate according to a modified exemplary embodiment.

FIG. 1 illustrates the construction in principle and essential components of a battery 10 having a plurality of flat cells 12-1 to 12-8 which are electrically connected in parallel and/or in series with one another.

The reference numbers of components which are provided several times in an embodiment but which are similar in their effect, such as the flat cells mentioned above for example, are numbered sequentially (in each case supplemented by a hyphen and a consecutive number). In the following, reference is also made to such individual components or to the totality of such components by the non-supplemented reference number.

The number of flat cells 12 shown in FIG. 1 is to be understood merely as an example. In particular, when the battery 10 is to be used as a high-power battery, e.g. as a traction battery in an electric or hybrid vehicle, then in fact significantly more, for example more than 50 or even more than 100, flat cells 12 could also be arranged in the manner shown in FIG. 1 for the flat cells 12-1 to 12-8.

In each case, the plate-shaped flat cells 12 have, for example, a rectangular form with a cell thickness which is significantly less than every lateral extension of the plate (e.g. smaller by at least a factor of 10).

The flat cells 12 can be formed from any kind of battery cells which are known per se. Nickel metal hydride, nickel cadmium zinc air, lithium air, nickel zinc and lithium ion cells are mentioned here purely by way of example.

The flat cells 12 are arranged next to one another in a row orthogonally with respect to their flat sides and, together with heat dissipating plates 14-1 to 14-4 inserted between them, form an overall prismatic, in this case for example square, arrangement 16.

The heat dissipating plates 14 are made from a good heat conducting material (e.g. from metal, such as aluminum for example, or similar).

In the exemplary embodiment shown, the flat cells 12 and the heat dissipating plates 14 are not assembled “densely packed” to form a gap-free arrangement 16 or a dense stack. Rather, gaps or openings 18-1 to 18-3, which can be used, for example, as air gaps or coolant passages for cooling (including general “temperature control”) of the battery 10, are also provided in the arrangement 16.

In the exemplary embodiment shown, the battery 10 further comprises a heat sink 20 which is formed from a good heat conducting material (e.g. aluminum or similar) and to which the heat dissipating plates 14 are not only thermally connected but also fixed. For this purpose, bottom edges of the heat dissipating plates 14, for example, can be inserted in suitably dimensioned grooves or recesses on the top of the heat sink 20, as shown in FIG. 1. Alternatively or in addition, the heat dissipating plates 14 can, for example, be screwed to the heat sink 20.

The electrical connection of the flat cells 12 to one another is not shown in the figure, but could be realized by appropriate cable connections, for example, to the top of the arrangement 16 which can be seen in FIG. 1, “spanning” the top edges of the heat dissipating plates. A monitoring and/or control device for the individual flat cells 12 (not shown), for example a so-called CSC device (“cell supervising circuit”), could also be arranged in this region.

One of the flat sides of each of the flat cells 12 makes planar contact (via a film of heat conducting paste) with an associated heat dissipating plate 14 and, in the exemplary embodiment shown, is glued and/or screwed thereto.

This ensures that, in the arrangement 16, a heat dissipating plate 14 is provided on at least one flat side of each flat cell 12 and is thermally connected thereto so that, advantageously, a heat dissipating path starting from each flat cell 12 leads via at least one heat dissipating plate 14 and further to the heat sink 20. By this means, all flat cells 12 can be efficiently cooled while the battery 10 is in operation, that is to say during requirement-based charging and discharging of the battery 10, wherein the mentioned air gaps or coolant gaps 18 can also contribute to this cooling. These gaps 18 can be connected to a suitable coolant circuit, for example.

A special feature of the battery 10 consists in that, in each case, at least one temperature sensor 22 is integrated in the heat dissipating plates 14. For the four heat dissipating plates 14-1, 14-2, 14-3 and 14-4 shown here by way of example, these are the depicted temperature sensors 22-1, 22-2, 22-3 and 22-4 respectively.

Advantageously, a spatially resolved battery temperature measurement corresponding to the arrangement of the sensors 22 can be carried out by means of the temperature sensors 22 while the battery 10 is in operation.

Based on an evaluation of the sensor signals, a specific (requirement-based) change in the cooling operation can be realized by means of a device which controls the air or coolant flow through the individual gaps 18-1 to 18-3. For example an electronic control device, which evaluates the temperature sensor signals, determines an individual cooling requirement for the individual gaps 18, and effects an appropriate actuation of electrically actuatable valves, by means of which the gaps 18 are supplied individually (or in certain groups thereof) with a coolant, can be provided for this purpose.

If, for example, the temperature sensor 22-3 shown in FIG. 1 indicates an excessively high temperature, then a coolant flow through the gaps 18-2 and 18-3 could be suitably increased in order to effect increased cooling in this spatial area of the battery 10. Alternatively or in addition, temperature abnormalities of this kind can be stored, for example, in an electronic storage device, in order to use information of this kind for a later specific replacement of one or more of the flat cells 12.

In the exemplary embodiment shown, one of the heat dissipating plates 14 is in each case thermally connected to only one of the two flat sides of each flat cell 12, whereas the flat sides of each flat cell 12 which in each case face away from this heat dissipating plate borders one of the gaps 18 or forms an end surface which finishes off the arrangement 16 in the “stacking direction”. Coolant gaps could also be provided at the left hand and right hand ends of the arrangement 16 in FIG. 1. Not shown in FIG. 1 is a battery housing which encloses the components shown.

It is understood that the geometry of the arrangement 16 specifically shown in FIG. 1 could be modified in many ways without at the same time dispensing with the advantageous possibility of a spatially resolved battery temperature measurement. In particular, it is in no way necessary in practice to provide as many heat dissipating plates (in comparison with flat cells) as illustrated in FIG. 1 (1 heat dissipating plate 14 for every 2 flat cells). A ratio of the number of heat dissipating plates to the number of flat cells in a range from 0.1 to 1 is generally preferred. Expediently, the heat dissipating plates should be distributed more or less uniformly over the length of the cell arrangement 16 (however, the density of heat dissipating plates in a central range of the arrangement could be somewhat increased compared with the ends of the arrangement, e.g. by a factor of 1.5 to 2).

In the following description of further exemplary embodiments, the same reference numbers are used for components which have the same effect, in each case supplemented by a lower-case letter to differentiate the embodiment. In doing so, essentially only the differences from the exemplary embodiment(s) already described are dealt with, and for the rest reference is hereby expressly made to the description of previous exemplary embodiments.

FIGS. 2, 3 and 4 illustrate an exemplary embodiment of a heat dissipating plate 14a which can be assembled or, in the fitted state, is assembled from two individual plates 26a and 28a.

FIG. 2 shows the inside of the plate 26a, including four temperature sensors 22a-1 to 22a-4, which, as shown, are connected by means of respective sensor cables (e.g. serial/parallel data bus cables) to a multiplexer 30a, of which, in turn, one data cable leads as shown to a sensor connection (e.g. plug-in connector) 32a which is located at an edge of or outside the plate 26a. In practice, there are many options for the specific design of the plate 26a with the sensors 22a, the multiplexer 30a and the corresponding sensor signal cables. For example, the sensors 22a can be in the form of unenclosed semiconductor chips on a ceramic substrate or similar, wherein, advantageously, semiconductor chips of this kind can also contain the interface electronics which is desired in the individual case. The multiplexer 30a can be designed in a similar way (as a semiconductor chip). If a body of the plate 26a is formed from an electrically conducting material, such as aluminum or some other metallic material for example, then it must be ensured that the data cables which run between the individual sensors 22a and the multiplexer 30a and between the multiplexer 30a and the connecting device 32a are electrically insulated in an appropriate manner. For example, all these components could in each case be formed on a plastic or ceramic substrate which, in turn, is connected flat to the inside of the plate 26a, wherein this connection should guarantee a low thermal resistivity with respect to the body of the plate (e.g. via a heat conducting film, e.g. adhesive film) at least in the region of the sensors 22a.

FIG. 3 shows the outside of the individual plate 28a. Regions 34a-1 to 34a-4, on which the temperature sensors 22a-1 to 22a-4 are placed in the assembled state of the heat dissipating plate 14a, are shown dashed. In the preferred embodiment of a plate body of the plate 28a in a metallic and therefore electrically conducting material, an appropriate electrical insulation with regard to the sensors is again to be provided if necessary. To achieve a low thermal contact resistance between the sensors 22a and the plate 28a, a heat conducting film for example (e.g. adhesive, heat conducting paste or self-adhesive heat conducting foils) can likewise be provided at the regions 34a.

In the exemplary embodiment shown, it is provided that the two individual plates 26a, 28a can be fixed to one another by means of corresponding fixing means 36a (on the plate 26a) and 38a (on the plate 28a) in order to create the heat dissipating plate 14a which is in the form of a structural unit for fitting into the battery concerned.

The configuration of the two individual plates 26a, 28a can more easily be seen in the perspective view of FIG. 4, wherein, in this figure, the two plates 26a, 28a are shown with a certain distance between them.

In the exemplary embodiment shown, the corresponding fixing means 36a, 38a are formed by latching pins (36a) and corresponding latching openings (38a). These enable the individual plates 26a, 28a to be easily stacked up and clipped together.

FIG. 5 shows an exemplary embodiment of the basic structure of a battery 10a which is produced using heat dissipating plates 14a according to FIGS. 2 to 4.

Again purely as an example, four such heat dissipating plates 14a-1, 14a-2, 14a-3 and 14a-4 are indicated as part of the battery 10a shown in FIG. 5. This number (in total and in comparison with the number of flat cells 12a) can in practice be matched to the particular application.

As with the exemplary embodiment according to FIG. 1, the heat dissipating plates 14a are in each case thermally connected to a common heat sink 20a at their bottom narrow side, and in each case carry one of the total of eight flat cells 12a-1 to 12a-8 on either side.

Notwithstanding the exemplary embodiment described with reference to FIG. 1, no gaps or openings are provided as air or coolant passages in the arrangement 16a. Rather, the arrangement 16a is a “densely packed” stack, in which the components 12a and 14a are directly connected flat against one another.

Purely by way of example, a region 42a of the flat cell 12a-8, in which an excessively high temperature (“hot spot”) occurs while the battery 10a is in operation, is shown dashed in FIG. 5.

Advantageously, such an abnormality can already be detected and localized while the battery 10a is in operation by means of the temperature sensors 22a which are arranged distributed over the volume (and the height) of the arrangement 16a.

In an operating method for the battery 10a, an increased cooling power for example, based on an evaluation of the temperature sensor signals can be effected in this case (e.g. by a controlled increased cooling of the heat sink 20a). Independently of this, information relating to the region 42a which indicates a defect in the flat cell 12a-8 can be stored in an electronic storage device.

FIG. 6 shows a further example of a heat dissipating plate 14b for use in a battery according to the invention.

As an example, the heat dissipating plate 14b could be used with the battery 10 according to FIG. 1 (as a specific form of the heat dissipating plate designated therein by 14) or with the battery 10a according to FIG. 5 (as a replacement for the heat dissipating plate 14a used therein). The heat dissipating plate 14b has a plate body, which is formed in one piece, for example from a metallic material such as aluminum or similar, with a temperature sensor 22b integrated therein in the centre of the plate surface. The sensor 22b is arranged in a recess 44b, for example in the form of a semiconductor sensor with a ceramic substrate connected flat to the base of the recess (e.g. glued).

At the top edge of the recess 44b in FIG. 6, this continues as a relatively narrow channel running upwards to a top edge of the heat dissipating plate 14b. A sensor signal cable runs in this channel in the fitted state of the plate 14b.

In the exemplary embodiment shown, the heat dissipating plate 14b as shown is intended for use in the battery concerned. Notwithstanding this, the right-hand flat side in FIG. 6 could optionally also be provided with a cover plate (e.g. glued-on metal plate).

Summing up, an advantageously spatially resolved temperature measurement can be carried out with the embodiment of a battery according to the invention or its use.

In practice, for the life of battery cells, along with good cooling overall, it is often even more important for this cooling to be as uniform as possible. In particular, no overly large temperature gradients should form viewed over the surface of the cells, and, in the case where a plurality of cells is connected to form the cell block arrangement described, there should be no larger temperature differences (from cell to cell) over this cell block either. The present invention offers significant advantages in this regard, as it enables a reliable measurement of the cell temperatures and, building on this, a specific temperature management for example. A temperature distribution between adjacent battery cells can be measured as well as the temperature distribution across one cell. The connection of the temperature sensors in the region of the heat dissipating plates is very robust and, with appropriate design, insensitive to mechanical effects such as vibration etc. Advantageously, regions with excessive temperature (“hot spots”) in the cells can be detected. If such regions occur, with appropriate control, a non-uniform temperature distribution viewed over the volume of the battery cell arrangement and/or over a cell surface can be counteracted by individually adjusting or increasing the flow quantity of a coolant appropriately for different coolant passages.

At least some heat dissipating plates (“cooling fins”) can be equipped with the temperature sensors described, wherein each heat dissipating plate concerned can in each case have one or more temperature sensors. Because of the cost aspect, only a few heat dissipating plates (compared with the total number of heat dissipating plates) can definitely be equipped with such sensors as well. In this case, the temperature sensors should be installed at least in a central region of the battery or battery cell arrangement.

Outside the heat dissipating plates, the sensor signal cables (e.g. bus cables) which are fed out of the individual heat dissipating plates can be combined with (connected to) a bus system, for example, which, for example, is in any case provided for connecting further sensors of the battery cells (e.g. “CSC”—cell supervising circuit).

The electrical connections of the temperature sensors can be incorporated in the heat dissipating plate as cables or printed circuit tracks, wherein the insulation of the cables can be achieved, for example by embedding them in ceramic or other non-conductive material. Printed circuit tracks can also be coated with insulating varnish, for example.

Advantageously, the integration of a temperature sensor by accommodating it in a recess of the heat dissipating plate concerned enables an increase in the plate thickness to be limited. In addition, in this case, the sensors concerned are well protected against mechanical loads.

When assembling the battery, it is very advantageous to use the heat dissipating plates with the already integrated temperature sensors as ready-to-fit units. This enables, for example, an at least partially automated stacking (laying of cell sets) of the heat dissipating plates with the battery cells.

1-10. (canceled)

11. A battery, comprising:
a plurality of flat cells electrically connected in at least one of parallel or series with one another, said flat cells having flat sides and being disposed next to one another in rows perpendicular to said flat sides forming a substantially prismatic configuration;
heat dissipating plates each having at least one respective temperature sensor integrated therein; and
at least one of said flat sides of a plurality of said flat cells in said configuration each having a respective one of said heat dissipating plates disposed thereon and thermally connected thereto.

12. The battery according to claim 11, wherein only one of said two flat sides of each of said flat cells has a respective one of said heat dissipating plates disposed thereon and thermally connected thereto.

13. The battery according to claim 11, wherein at least some of said heat dissipating plates are thermally connected to adjacent flat cells on both sides.

14. The battery according to claim 11, wherein all of said heat dissipating plates are thermally connected to adjacent flat cells on both sides.

15. The battery according to claim 13, wherein said flat sides of each two of said flat cells, each facing away from a respective one of said heat dissipating plates, delimit an air gap or a coolant passage therebetween.

16. The battery according to claim 11, which further comprises a heat sink, said heat dissipating plates having narrow sides, and one of said narrow sides of each of said heat dissipating plates being thermally connected in common to said heat sink.

17. The battery according to claim 11, wherein each of said heat dissipating plates is made up of two individual plates between which at least one temperature sensor is inserted.

18. The battery according to claim 11, wherein at least one temperature sensor is disposed in a recess formed in one of said heat dissipating plates.

19. The battery according to claim 11, wherein at least two temperature sensors are spaced apart from one another and integrated in one of said heat dissipating plates in at least one lateral direction of said one heat dissipating plate.

20. The battery according to claim 19, which further comprises a multiplexer integrated in said one heat dissipating plate and configured to operate said at least two temperature sensors.

21. The battery according to claim 11, wherein said temperature sensor is configured for a spatially resolved battery temperature measurement.
